(19) United States
(12) Patent Application Publication
(10) Pub. No.: US 2007/0165122 A1
(43) Pub. Date: Jul. 19, 2007

(54) Video signal clamping circuit

(76) Inventors: Keiichi Tsumura, Hyogo (JP); Shinji Yamamoto, Osaka (JP)

Correspondence Address: MCDERMOTT WILL & EMERY LLP, 600 13TH STREET, NW, WASHINGTON, DC, 20005-3096, US

(21) Appl. No.: 11/654,500

(22) Filed: Jan. 18, 2007

(30) Foreign Application Priority Data
Jan. 19, 2006 (JP) 2006-010923

(51) Int. Cl. H04N 5/16; H04N 5/18

(52) U.S. Cl. 348/257; 348/695

(57) ABSTRACT

A filter performs a filtering process by sampling a digital video signal only for an OB period. A first subtracter subtracts an OB data target value from the output value of the filter. A second subtracter sets a subtraction amount based on the subtracted result of the first subtracter and subtracts the subtraction amount from the digital video signal. A digital analog converter converts the subtracted result of the first subtracter to an analog signal and outputs it to an analog clamper. The analog clamper performs a subtracting process to an analog video signal based on the output value of the digital analog converter.

### BACKGROUND OF THE INVENTION

1. Field of the Invention

The present invention relates to a video signal clamping circuit and a video signal processing apparatus such as a digital camera and a television using this video signal clamping circuit.

2. Description of the Related Art

Conventionally, as shown in Japanese Unexamined Patent Publication No. 2000-106654, a video signal clamping circuit used in a video signal processing apparatus such as a digital camera (digital still camera, digital video camera, mobile phone with camera and the like) and a television includes the one comprising only an analog clamper and the one comprising an analog clamper and a digital clamper as a higher-precision circuit. Thus, a video signal clamping circuit in which both high precision and high speed convergence are implemented can be provided.

The above conventional example will be described with reference to FIG. 2. First, an analog video signal input S201 is inputted to a CDS/AGC 201. The CDS stands for a correlation double sampler that prevents the influence of a reset noise by sampling the difference between a reset level and a pixel level. The AGC stands for an analog gain controller.

An analog OB (Optical Black) clamping signal S208 is a signal to distinguish an OB part on which analog OB is desired to clamp from the other parts except for it. An analog clamper 202 adjusts the analog OB level of an output S202 from the CDS/AGC 201. This adjustment is made as follows. That is, capacity to selectively determine the analog OB level of the OB part in the video signal determinedly the analog OB clamping signal S208 is provided and then the above adjustment is implemented by charging and discharging to the capacity.

An output S203 of the analog clamper 202 is converted to a digital value with an ADC (Analog Digital Converter) 203. An output S204 of the ADC 203 is inputted to a digital clamper 204. The digital clamper 204 comprises a filter 205, a subtracter 206, and a subtracter 207. A digital OB clamping signal S209 is a signal to distinguish an OB part on which analog OB is desired to clamp from the other parts except for it. The filter 205 performs a filtering operation by selectively sampling the OB part determined by the digital OB clamping signal S209 in the output S204 from the ADC 203. The filtering operation is performed in order to suppress the influence of the noise. Thereafter, an OB level target value S210 is subtracted and a subtraction S206 between the present OB level and the OB level target value is calculated. A digital video signal output S207 is obtained by subtracting the calculated subtraction S206 from-the output S204 from the ADC 203. Thus, in the conventional example, the video signal clamping circuit comprises the analog clamper and the digital clamper where they are separately constituted and converge the output independently.

According to the above conventional video signal clamping circuit, the response speed in the digital clamper is high when the OB level varies. However, the response speed in the analog clamper is low because all of the desired processes are performed by the analog processing, therefore there is a problem that it takes time to provide a stable image.

### SUMMARY OF THE INVENTION

Thus, it is a main object of the present invention to provide a video signal clamping circuit in which convergence is implemented with high precision and at high speed.

In order to solve the above problem, according to the video signal clamping circuit in the present invention, OB data filtered in a digital clamper is converted to an analog signal by a DAC and this is fedback to an analog clamper for subtraction and an OB level is roughly adjusted at high speed. Then, data roughly adjusted with the analog clamper is finely adjusted with the digital clamper, so that a high-precision video signal clamping circuit is realized. The video signal clamping circuit can be realized striking a balance between high precision and high speed in convergence

The video signal clamping circuit in the present invention is useful for a video signal processing apparatus such as a digital camera (digital still camera, digital video camera, mobile phone with camera and the like) and a television.

### BRIEF DESCRIPTION OF THE DRAWINGS

Other objects of the present invention will be clear by understanding embodiments that will be described below and clearly specified in the appended claims. Implementation of the present invention reminds the person skilled in the art of many advantages that are not described in this specification.

FIG. 1 is a block diagram showing the constitution of a video signal processing apparatus comprising a video signal clamping circuit according to one embodiment of the present invention;

FIG. 2 is a block diagram showing a conventional example;

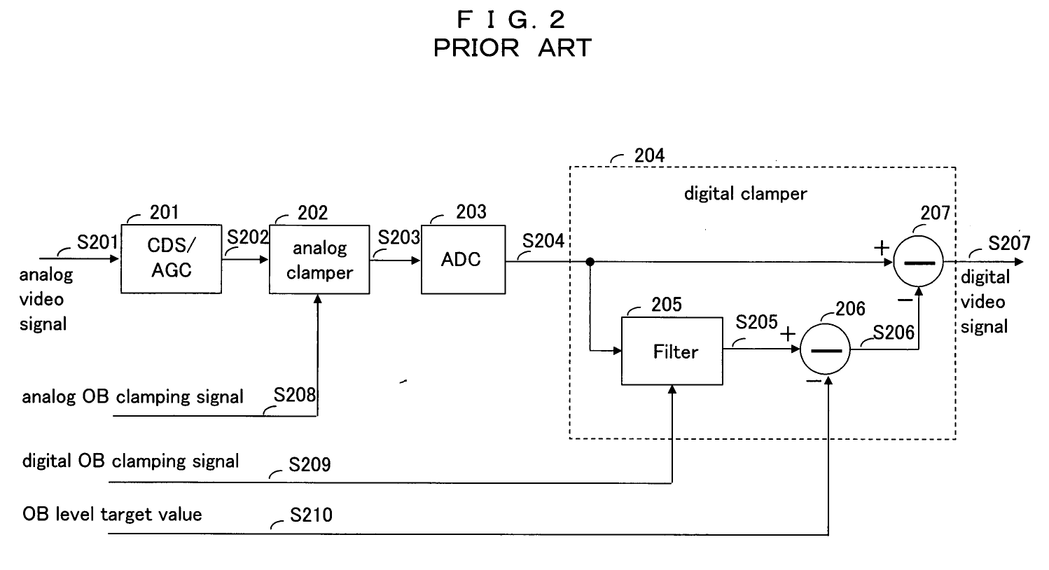

FIG. 3 is a timing chart using an IIR filter as a filter 105;

FIG. 4 is a timing chart using a filtering process by the pixel and a filtering process by the horizontal period in combination of them as the filter 105; and

FIG. 5 is a block diagram showing the constitution of a video signal processing apparatus comprising a video signal clamping circuit according to a variation of the present invention.

### DETAILED DESCRIPTION OF THE INVENTION

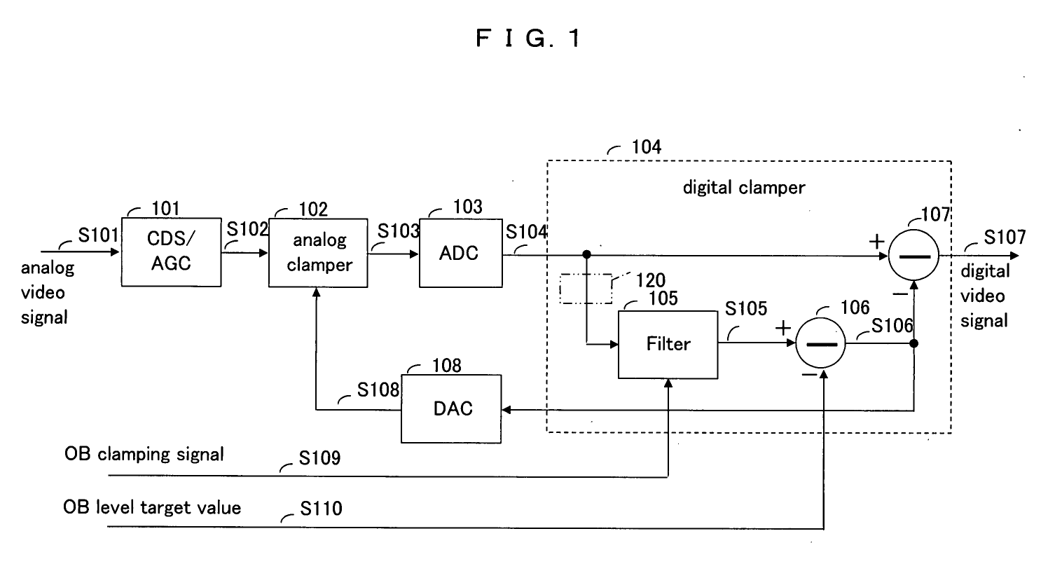

Hereinafter, a preferred embodiment of the present invention will be described with reference to the drawings. FIG. 1 is a block diagram showing the constitution of a video signal processing apparatus comprising a video signal clamping circuit according to one embodiment of the present invention.

The video signal clamping circuit included in this video signal processing apparatus comprises a CDS (Correlation Double Sampler)/AGC (Analog Gain Controller) 101, an analog clamper 102, ADC (Analog Digital Converter) 103, a digital clamper 104, and DAC (Digital Analog Converter) 108. The digital clamper 104 comprises a filter 105, a first subtracter 106 and a second subtracter 107. The DAC 108 reconverts a subtraction S106 outputted from the first subtracter 106, to an analog signal. The analog clamper 102 subtracts a subtraction S106 from an output (analog video signal) S102 from the CDS/AGC 101. The constitution is basically the same as the one described in the conventional example except for the DAC 108 and the analog clamper 102.

Hereinafter, the operation of the video signal clamping circuit will be described. An analog video signal S101 outputted from an image pickup device such as a CCD or received as a television signal is inputted into the CDS/AGC 101. The CDS/AGC 101 executes gain control so that the analog video signal S101 stays within a predetermined level range while reduces the influence of a reset noise, by sampling the difference between a reset level and a pixel level.

The analog video signal S102 processed by the CDS/AGC 101 is inputted to the analog clamper 102 and the OB level of the analog video signal S102 is roughly adjusted by analog processing. An analog video signal S103 whose OB level was roughly adjusted by the analog clamper 102 is inputted to the ADC 103 and converted to a digital video signal S104 here. The digital video signal S104 is inputted to the digital clamper 104.

The filter 105 of the digital clamper 104 determines an OB part in the digital video signal S104 based on an OB clamping signal (that distinguishes the OB part from others) S109. In addition, when the image pickup device is the CCD, few peripheral pixels in its effective pixels are set as an OB region and light is not applied to it in general. The filter 105 selectively samples the OB part of the determined digital video signal S204 to perform a filtering operation. This filtering operation is performed to suppress the influence of the noise, for example, this is realized by an IIR filter.

A digital video signal S105 obtained by filtering operation in the filter 105 is inputted to the first subtracter 106 in which an OB level target value S110 is subtracted from the digital video signal S105. The OB level target value S110 has been previously set. The OB level target value S110 is the OB level targeted in the video signal processing and set in general to a given value greater than “0”. The subtraction S106 that is the subtracted result is supplied to the second subtracter 107 and the DAC 108.

The DAC 108 reconverts the subtraction S106 to the analog signal S108 and supplies it to the analog clamper 102. The analog clamper 102 subtracts the analog signal S108 from the analog video signal S102 to roughly adjust the OB level in the analog video signal S102 so that the OB level comes close to the OB level target value S110.

The second subtracter 107 subtracts the subtraction S106 from the output S204 from the ADC 203 to generate a digital video signal output S207 and outputs it. Here, the second subtracter 107 subtracts the subtraction S106 from the digital video signal S104 by the digital process to finely adjust the OB level of the digital video signal S107 so that the OB level comes close to the OB level target value as much as possible. Thus, the clamping process is performed so as to make an offset adjustment so that the OB level comes close to the target value.

Since the processes of the filter 105 and the first and second subtracters 106 and 107 are digital processes, the speed is higher than the conventional analog clamping process, and the analog conversion by the DAC 108 is performed at a speed higher than the process of the analog clamper. Therefore, according to the above constitution, the subtraction can be fed back to the analog clamper at a speed higher than in the prior art, so that the OB level can be expected to be converged at high speed.

Here, the reason why the rough adjustment is made in the analog clamper 102 and the fine adjustment is made in the digital clamper 104 will be described hereinafter. The digital clamper 102 can adjust the OB level at LLSB ideally when the influence of the noise can be ignored. Therefore, the OB level can be finely adjusted by the digital clamper 102. However, since the bit width of the digital signal has been determined, when the OB level of the analog video signal S101 largely varies, an effective dynamic range in the ADC 103 is reduced. Even when the OB level of the analog video signal S101 largely varies, it is necessary to roughly adjust the OB level in the analog clamper 102 in order to effectively use the effective dynamic range in the ADC 103 to a maximum extent. In addition, since the analog clamper 102 only makes the rough adjustment, the resolution of the DAC 108 may be lower than that of the ADC 103.

Furthermore, when an interpolator 120 that removes a scratch and a noise, or interpolates peripheral data is provided just before the filter 105 as shown by a virtual line in FIG. 1, the precision for obtaining the OB level can be enhanced.

In addition, when the video signal input is a color signal, the digital clamper 104 may be provided for each color and the filtering process and the digital clamping process may be performed with respect to each color. By doing this, even when there is a difference in OB level among colors, the OB clamping can be performed with high precision.

Furthermore, when the output range of the DAC 108 is made variable, the controllable potential range of the analog clamper 102 can be selected. In this case, when the precision of the clamping control is given priority, the output range may be narrowed to enhance the resolution of the DAC 108. When to expand the clamping control range is given priority, the output range of the DAC 108 may be widened.

In addition, the subtracting process (processing to subtract the subtraction S106 from the digital video signal S104) in the second subtracter 107 may be performed every predetermined number of horizontal periods, or every predetermined number of frame periods. More specifically, the filter 105 performs the filtering process and holds the OB level while sequentially updates it. Thus, the filter 105 outputs the OB level to the second subtracter 107 through the first subtracter 106 every predetermined number of horizontal periods or every predetermined number of frame periods. In this case, the digital clamping variation does not affect the digital video signal S107 in a period shorter than the predetermined number of horizontal periods or the predetermined number of frame periods (short range) Therefore, an output image is stable in the short range. In addition, the OB level may be held in the first subtracter 106.

Additionally, the subtraction S106 may be supplied to the DAC 108 every predetermined number of horizontal periods or every predetermined number of frame periods. More specifically, though the filter 105 performs the filtering process and holds the OB level while sequentially updates it, the filter 105 supplies the OB level to the DAC 108 through the first subtracter 106 every predetermined number of horizontal periods or every predetermined number of frame periods. In this case, the digital clamping variation does not affect the digital video signal S107 in a period shorter that the predetermined number of horizontal periods or the predetermined number of frame periods (short range). Therefore, an output image is stable in the short range.

In addition, if the coefficient of the filter 105 is made variable, the speed of convergence can be controlled. At this time, even when the filtering coefficient is changed, it is desirable that the value of the output S105 of the filter 105 does not fluctuate just before and just after the coefficient change by devising the circuit.

In addition, the filter 105 may be constituted so that the filtering process performed by the pixel and the filtering process performed by the horizontal periods are combined. By devising the filtering coefficient in this combination, output vibration of the filter 105 required for converging the OB variation can be suppressed.

Furthermore, when the absolute value of the subtraction S106 inputted to the DAC 108 is increased, this output vibration is likely to be generated. Thus, when the absolute value of the subtraction S106 is great, the circuit constitution may as well taken so that the output (subtraction S106) of the first subtracter 106 is fed back to the filter 105 so as to decrease the output variation in the output S105 of the filter 105.

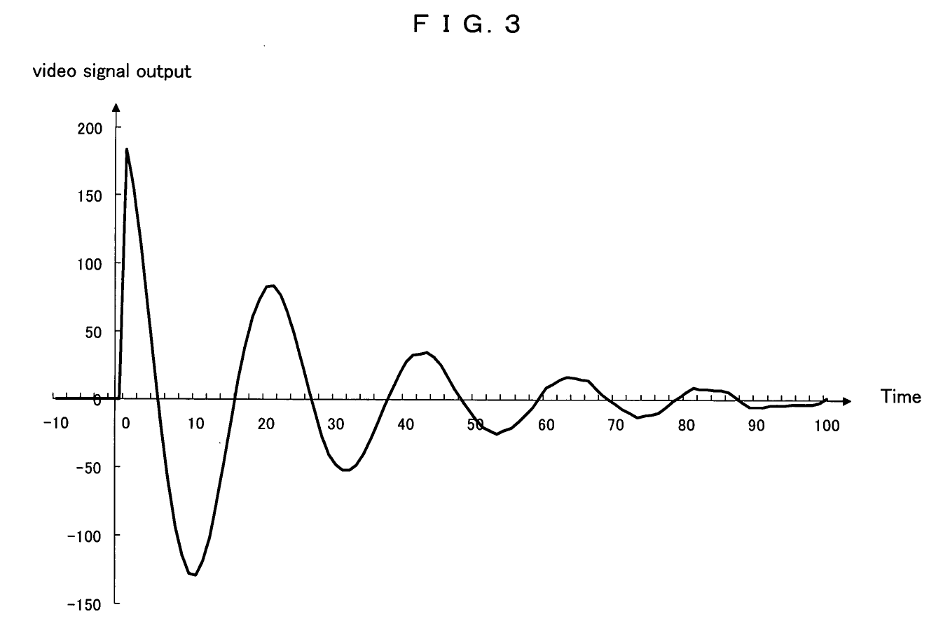

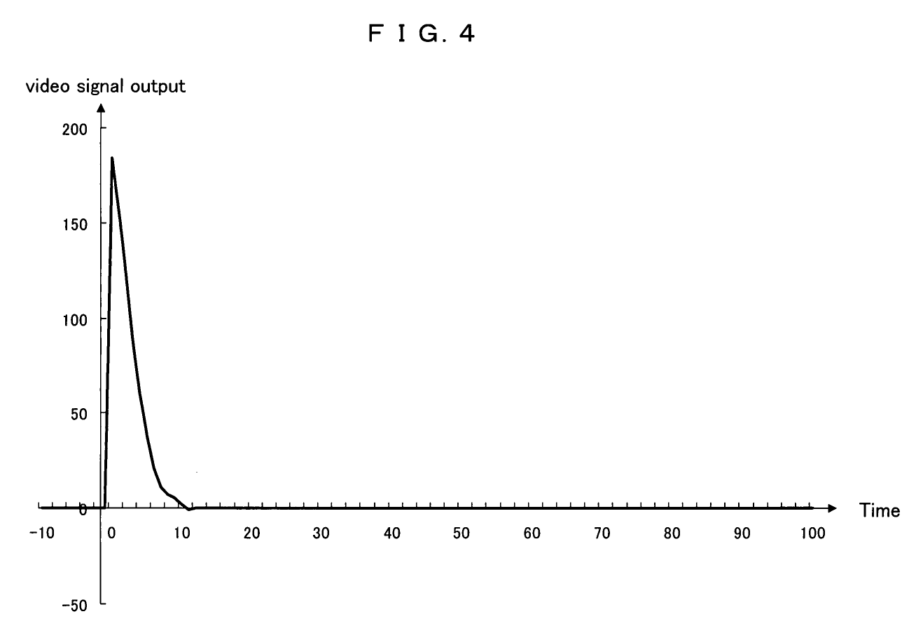

FIG. 3 shows the timing chart of a digital video signal output under a state where the analog video signal input OB varies at a time 0 in a constitution using a simple IIR filter as the filter 105. Meanwhile, FIG. 4 shows the timing chart similar to the above, in the circuit constitution in which the subtraction S106 is fed back to the filter 105 so that the variation in the filter output becomes small. It can be found in FIG. 4 in comparison with FIG. 3 that the output is converged at high speed while prevented from vibrating.

In addition, an IIR filter may be used instead of the FIR filter as the filter 105. The IIR filter has the advantage that it is simple and a circuit size is small compared with the FIR filter.

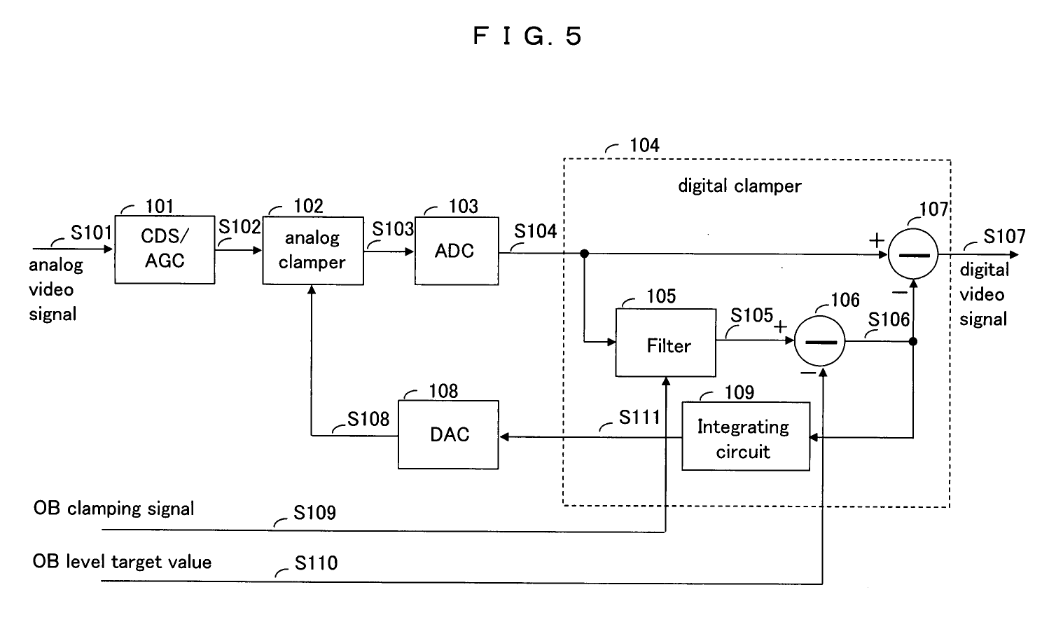

Furthermore, as shown in FIG. 5, an integrating circuit 109 may be provided between the output of the first subtracter 106 and the DAC 108. By doing this, although the convergence is delayed a little, it is prevented from being affected by the noise.

As described above, according to the present invention, the subtraction S106 obtained through the digital subtracting process with the digital clamper 104 is fed back to the analog clamper 102 so as to be subtraction amount. Thus, the high-speed convergence can be implemented. Furthermore, since the signal is roughly adjusted by the analog clamper 102 and then finely adjusted by the digital clamper 104, a high-precision video signal clamping circuit can be realized.

Although the present invention has been described with the most preferable embodiments, the present invention is not limited to the above-illustrated embodiments. Various kinds of modifications and variations may be added to the illustrated embodiments within the same or equal scope of the present invention.

What is claimed is:

1. A video signal for clamping circuit comprising:
an analog clamper for performing a subtracting process to an analog video signal;
an analog digital converter for converting the analog video signal outputted from the analog clamper to a digital video signal;
a filter for performing a filtering process by sampling the digital video signal outputted from the analog digital converter only for an OB period;
a first subtracter for subtracting an OB data target value from the output value of the filter;
a second subtracter for setting a subtraction amount based on the subtracted result of the first subtracter, and subtracting the subtraction amount from the digital video signal outputted from the analog digital converter; and
a digital analog converter for converting the subtracted result of the first subtracter to an analog signal and outputting it to the analog clamper, wherein
the analog clamper performs the subtracting process based on the output value of the digital analog converter.

2. The video signal clamping circuit according to claim 1, further comprising an interpolator previously interpolating a scratch and a noise of the digital video signal before the filtering process for the digital video signal outputted from the analog digital converter is performed with the filter.

3. The video signal clamping circuit according to claim 1, wherein
the analog video signal corresponds to a color and the filtering process with the filter is performed with respect to each color and the subtractions by the first subtracter and the second subtracter are performed with respect to each color.

4. The video signal clamping circuit according to claim 1, wherein
the output range of the digital analog converter is variable.

5. The video signal clamping circuit according to claim 1, wherein
the subtraction amount in the second subtracter is updated every predetermined number of horizontal periods or every predetermined number of frames based on the output value of the filter.

6. The video signal clamping circuit according to claim 1, wherein
the output value of the digital analog converter is updated every predetermined number of horizontal periods or every predetermined number of frames based on the output value of the filter.

7. The video signal clamping circuit according to claim 1, wherein
the filter coefficient of the filter is made variable.

8. The video signal clamping circuit according to claim 7, wherein
the output value of the filter before and after the filter coefficient is changed is the same.

9. The video signal clamping circuit according to claim 7, wherein
the filter combines the filtering process by the pixels and the filtering process by the horizontal period to perform the filtering process.

10. The video signal clamping circuit according to claim 1, wherein the filter comprises an IIR filter.

11. A video signal clamping circuit comprising:
an analog clamper for performing an analog clamping process; and
a digital clamper for performing a digital clamping process, wherein
an intermediate result in the digital clamper is fed back to the analog clamper, and
the analog clamper performs a clamping process based on the fed-back value from the digital clamper.

12. The video signal clamping circuit according to claim 11, wherein
the digital damper comprises:
a filter for performing a predetermined filtering process by sampling a digital signal in an OB region in a digital video signal; and
a first subtracter for subtracting a target OB level from the signal to which a filtering process is executed,
wherein the output of the first subtracter is converted to an analog signal and supplies it to the analog clamper as a feedback signal.

13. The video signal clamping circuit according to claim 12, wherein
the digital clamper further comprises a second subtracter, and wherein
the second subtracter subtracts a subtraction amount based on the subtracted result of the first subtracter, from the digital video signal.

14. A video signal processing apparatus having the video signal clamping circuit according to claim 1.

15. A video signal processing apparatus having the video signal clamping circuit according to claim 11.
